(19) United States
(12) Patent Application Publication
(10) Pub. No.: US 2007/0052386 A1
(43) Pub. Date: Mar. 8, 2007

(54) Automatic chargeable electromotive vehicle

(76) Inventor: Yi-Hsiung Lin, Tainan City (TW)

Correspondence Address: Yi-Hsiung Lin, P.O. Box 90, Tainan City, 70499, TW

(21) Appl. No.: 11/220,533

(22) Filed: Sep. 8, 2005

(51) Int. Cl. H02J 7/00

(52) U.S. Cl. 320/104

(57) ABSTRACT

An automatic changeable electromotive vehicle has a driving device. The driving device of the electromotive vehicle is connected to a battery and a generator to form an electric loop. A switch is connected between the battery and the driving device. Therefore, when the switch of the electromotive vehicle is turned on, the battery provides power to the driving device so as to drive the electromotive vehicle. While the driving device also drives the generator to operate, the generator precedes battery to charge. The electromotive vehicle is chargeable automatically during driving. Thus, not only the battery of the electromotive vehicle is charged in driving, but also the traveling distance of the electromotive vehicle is increased.

### FIELD OF THE INVENTION

The present invention relates to electromotive vehicles, and particularly to an auto-chargeable electromotive vehicle capable of charging power automatically. A driving device of the electromotive vehicle is connected to a battery and a generator so as to form a loop. A switch is connected between the battery and the driving device. Therefore, when the switch of the electromotive vehicle is turned on, the battery provides power to the driving device so as to drive the electromotive vehicle. While the driving device also drives the generator to operate, the generator causes the battery to charge power. The electromotive vehicle is capable of charging automatically in driving. Thus, not only the battery of the electromotive vehicle is charged in driving, but also the traveling distance of the electromotive vehicle are increased.

### BACKGROUND OF THE INVENTION

FIG. 1 illustrates an electromotive vehicle 1 of prior arts. The electromotive vehicle 1 of prior arts has a battery 11. The battery 11 is connected to the driving device 12 of the electromotive vehicle 1. When the electromotive vehicle 1 is turned on, the battery 11 provides power to drive the electromotive vehicle 1. However, when power of the battery 11 is almost consumed, the electromotive vehicle cannot be driven. The battery 11 must be charged for restarting the electromotive vehicle.

### SUMMARY OF THE INVENTION

Accordingly, the primary object of the present invention is to provide an electromotive vehicle. A generator of the electromotive vehicle is used to provide a function of charging a battery so as to increase the traveling distance of the electromotive vehicle.

In order to achieve the object of the present invention, the driving device of the electromotive vehicle is connected to a battery and a generator so as to establish a loop. A switch is connected between the battery and the driving device.

The various objects and advantages of the present invention will be more readily understood from the following detailed description when read in conjunction with the appended drawing.

### BRIEF DESCRIPTION OF THE DRAWINGS

FIG. 1 is a perspective view of an electromotive vehicle of a prior art.

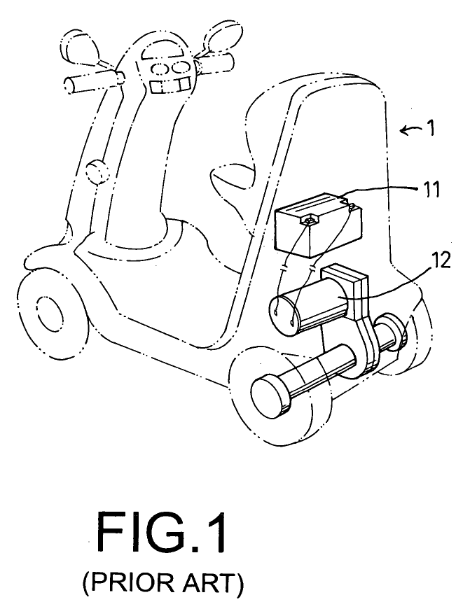

FIG. 2 is a perspective view of the present invention.

FIG. 3 is a perspective view showing the circuit board of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

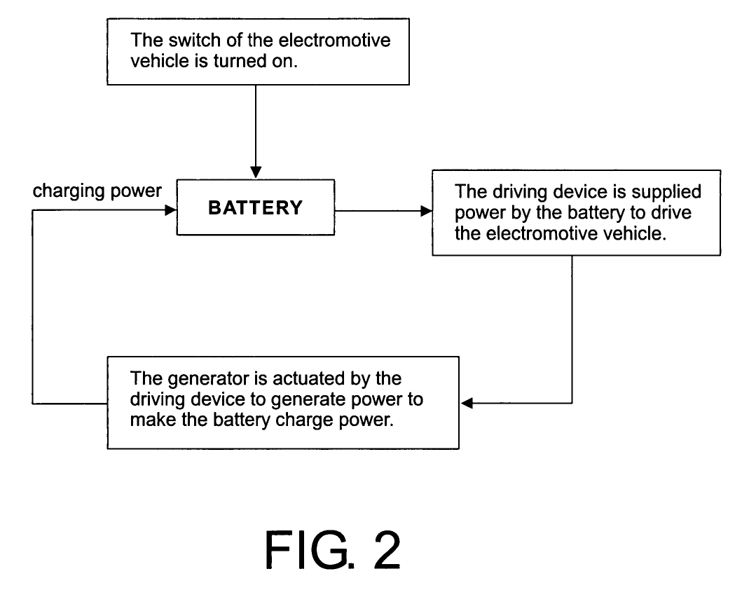

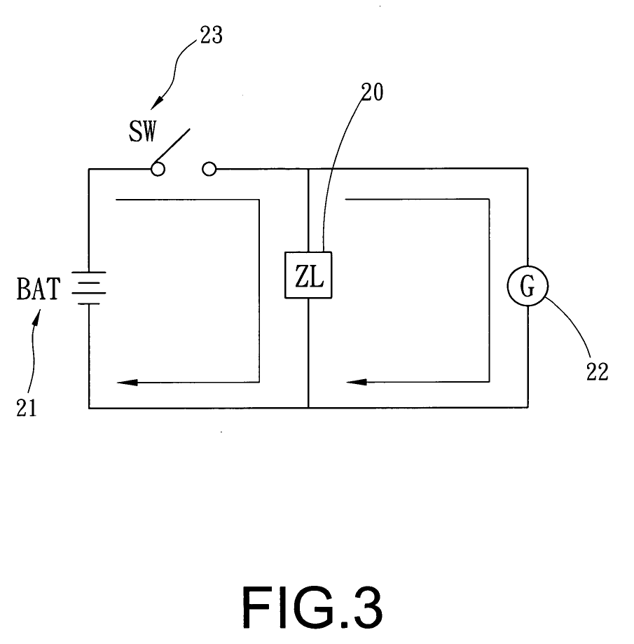

Referring to FIG. 2 and FIG. 3, a driving device 20 of an electromotive vehicle is connected to a battery 21 and generator 22 so as to establish a loop. A switch 23 is connected between the battery 21 and driving device 20. When the switch 23 of the electromotive vehicle is turned on, the battery 21 supplies power to the driving device 20 to drive the electromotive vehicle. The driving device 20 also actuates the generator 22 to generate power, and the generator 22 causes the battery 21 to charge power.

Therefore, when the electromotive vehicle is driving, the driving device 20 of the electromotive vehicle drives the generator 22 not only to generate electric power, but also to charge the battery 21. The electromotive vehicle is capable of charging automatically in driving. Thus, not only the battery 21 of the electromotive vehicle is charged during driving, but also the traveling distance of the electromotive vehicle is increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatically chargeable electromotive vehicle comprising:
a battery;
a generator;
a driving device connected between the battery and the generator;
a switch connected between the battery and the driving device; and
wherein when the switch of the electromotive vehicle is turned on, the battery supplies power to the driving device to drive the electromotive vehicle; the driving device also drives the generator to generate power, and the generator actuates the battery to charge power; the electromotive vehicle is chargeable automatically while driving; and not only the battery of the electromotive vehicle is charged during driving, but also the traveling distance of the electromotive vehicle is increased.

2. The automatically chargeable electromotive vehicle as claimed in claim 1, wherein the vehicle is one of a car or a motorcycle.
